(19) United States
(12) Patent Application Publication
(10) Pub. No.: US 2017/0075169 A1
(43) Pub. Date: Mar. 16, 2017

(54) BACKLIGHT UNITS AND METHODS OF MAKING THE SAME

(71) Applicant: EMPIRE TECHNOLOGY DEVELOPMENT LLC, Wilmington, DE (US)

(72) Inventor: Hidekazu Hayama, Osaka (JP)

(73) Assignee: EMPIRE TECHNOLOGY DEVELOPMENT LLC, Wilmington, DE (US)

(21) Appl. No.: 15/122,934

(22) PCT Filed: Mar. 4, 2014
(86) PCT No.: PCT/US14/20275

§ 371 Date: Sep. 1, 2016

(51) Int. Cl. G02F 1/1335; G02F 1/1368

(52) U.S. Cl. CPC G02F 1/133617; G02F 1/1368; G02F 1/133615; G02F 2001/133614; G02F 2001/133302

(57) ABSTRACT

A backlight unit for a LCD can include a TFT array substrate, a UV light source disposed at an edge or bottom of the TFT array substrate, and a layer of transparent fluorescent films formed on the TFT array substrate. The layer of transparent fluorescent films can include a plurality of red transparent fluorescent films, a plurality of green transparent fluorescent films, and a plurality of blue transparent fluorescent films. The layer of transparent fluorescent films can function as a color filter. In some embodiments, a light guide plate and a conventional color filter are omitted from the LCD.

### BACKGROUND

Smartphones, tablets, personal computers (PCs), and devices with liquid crystal displays (LCDs) have recently formed large markets, become popular types of mobile terminals, and changed the lifestyles of users dramatically. However, there remains a need to reduce the weight, thickness, and cost of these devices. Due to the large number of components in a conventional LCD, it is difficult to reduce the weight, thickness, and cost of the LCD device as well as the cost, time, and complexity of the manufacturing process.

### SUMMARY

In some embodiments, a backlight unit can comprise a thin film transistor array substrate; at least one ultraviolet light source configured to project ultraviolet light through the thin film transistor array substrate; and at least one layer of transparent fluorescent films formed on a top surface of the thin film transistor array substrate, wherein the layer comprises: a plurality of red transparent fluorescent films formed on a first subset of pixels on the top surface of the thin film transistor array substrate; a plurality of green transparent fluorescent films formed on a second subset of pixels on the top surface of the thin film transistor array substrate; and a plurality of blue transparent fluorescent films formed on a third subset of pixels on the top surface of thin film transistor array substrate, wherein the layer of transparent fluorescent films is configured to filter color.

In some embodiments, a liquid crystal display can comprise a backlight unit comprising a thin film transistor array substrate; at least one ultraviolet light source configured to project ultraviolet light through the thin film transistor array substrate; and at least one layer of transparent fluorescent films formed on the thin film transistor array substrate, wherein the layer comprises: a plurality of red transparent fluorescent films formed on a first subset of pixels on the thin film transistor array substrate; a plurality of green transparent fluorescent films formed on a second subset of pixels on the thin film transistor array substrate; and a plurality of blue transparent fluorescent films formed on a third subset of pixels on the thin film transistor array substrate, wherein the layer of transparent fluorescent films is configured to filter color. In some embodiments, the liquid crystal display can further comprise a liquid crystal layer disposed above the layer of transparent fluorescent films; and a glass substrate without a color filter formed thereon, wherein the glass substrate is disposed above the liquid crystal layer.

In some embodiments, a device comprising a liquid crystal display can comprise a liquid crystal display comprising a backlight unit comprising a thin film transistor array substrate; at least one ultraviolet light source configured to project ultraviolet light through the thin film transistor array substrate; and at least one layer of transparent fluorescent films formed on the thin film transistor array substrate, wherein the layer comprises: a plurality of red transparent fluorescent films formed on a first subset of pixels on the thin film transistor array substrate; a plurality of green, transparent fluorescent films formed on a second subset of pixels on the thin film transistor array substrate; and a plurality of blue transparent fluorescent films formed on a third subset of pixels on the thin film transistor array substrate, wherein the layer of transparent fluorescent films is configured to filter color. In some embodiments, the liquid crystal display can further comprise a liquid crystal layer disposed above the layer of transparent fluorescent films; and a glass substrate without a color filter formed thereon, wherein the glass substrate is disposed above the liquid crystal layer, In some embodiments, the device can be a mobile device, a cell phone, a tablet, a computer, a television, a monitor, or a display.

In some embodiments, a method of making a backlight unit can comprise providing a thin film transistor array substrate; disposing at least one ultraviolet light source at an edge of or beneath the thin film transistor array substrate so that the at least one ultraviolet light source is configured to project ultraviolet light through the thin film transistor array substrate; and forming at least one layer of transparent fluorescent films configured to filter color on a thin film transistor array substrate, wherein forming the layer comprises: forming a plurality of red transparent fluorescent films on a first subset of pixels on the thin film transistor array substrate, forming a plurality of green transparent fluorescent films on a second subset of pixels on the substrate; and forming a plurality of blue transparent fluorescent films on a third subset of pixels on the substrate.

In some embodiments, a method of forming a red transparent fluorescent film on a thin film transistor array substrate can comprise providing a red transparent fluorescent material; mixing the red transparent fluorescent material with a transparent resin based ink, thereby yielding a red transparent fluorescent ink; applying the red transparent fluorescent ink to a subset of pixels on the thin film transistor array substrate; and drying the red transparent fluorescent ink.

In some embodiments, a method of forming a green transparent fluorescent film on a thin film transistor array substrate can comprise providing a green transparent fluorescent material; mixing the green transparent fluorescent material with a transparent resin based ink, thereby yielding a green transparent fluorescent ink; applying the green transparent fluorescent ink to a subset of pixels on the thin film transistor array substrate; and drying the green transparent fluorescent ink.

In some embodiments, a method of forming a blue transparent fluorescent film on a thin film transistor array substrate can comprise providing a blue transparent fluorescent material; mixing the blue transparent fluorescent material with a transparent resin based ink, thereby yielding a blue transparent fluorescent ink; applying the blue transparent fluorescent ink to a subset of pixels on the thin film transistor array substrate; and drying the blue transparent fluorescent ink.

In some embodiments, a method of using a backlight unit can comprise providing a backlight unit comprising: a thin film transistor array substrate; at least one ultraviolet light source configured to project ultraviolet light through the thin film transistor array substrate; at least one layer of transparent fluorescent films formed on the thin film transistor array substrate, wherein the layer comprises: a plurality of red transparent fluorescent films formed on a first subset of pixels on the thin film transistor array substrate; a plurality of green transparent fluorescent films formed on a second subset of pixels on the thin film transistor array substrate; a plurality of blue transparent fluorescent films formed on a third subset of pixels on the thin film transistor array substrate, wherein the layer of transparent fluorescent films is configured to filter color. In some embodiments, a method of using a backlight unit can further comprise projecting the ultraviolet light through the thin film transistor array substrate, thereby causing the emission of red light from the red transparent fluorescent films, the emission of green light from the green transparent fluorescent films, the emission of blue light from the blue transparent fluorescent films, or a combination thereof.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates a cross-sectional view of a conventional LCD.

FIG. 2 illustrates a cross-sectional view of a LCD according to one embodiment.

FIG. 3 illustrates a top perspective view of a layer of transparent fluorescent films according to one embodiment.

FIG. 4 illustrates a method of making a backlight unit for a LCD according to one embodiment.

FIG. 5 illustrates a method of making a red material for a red transparent fluorescent film according to one embodiment.

FIG. 6 is a graph showing the amount of ultraviolet absorbed by six samples of a red transparent fluorescent film, each having a different amount of thenoyltrifluoroacetone.

FIG. 7 is a graph showing the light excitation and emission spectra of six samples of a red transparent fluorescent film, each having a different amount of thenoyltrifluoroacetone

FIG. 8 is a graph showing the light excitation and emission spectra of a green transparent fluorescent film.

FIG. 9 is a graph showing the light excitation and emission spectra of a blue transparent fluorescent film.

FIG. 10 is a graph showing the light excitation and emission spectra of a layer of transparent fluorescent films having red, green, and blue transparent fluorescent films arranged in a mosaic pattern with uniform area ratios.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Conventional liquid crystal display (LCD) devices include multiple components that add to the weight, thickness, and manufacturing costs of the device. Examples of such components include a glass substrate for a thin-film transistor (TFT) array, thin-film transistors, a glass substrate for a color filter, a color filter, transparent electrodes, polarizers, alignment layers, a liquid crystal layer, a light guide plate, and multiple other components. In contrast, the embodiments disclosed herein are able to omit a light guide plate and a conventional color filter. Conventional LCDs typically project white light through a light guide plate disposed beneath the TFT array substrate. On the other hand, some embodiments disclosed herein project ultraviolet (UV) light directly through the TFT array substrate, thereby avoiding the need for a conventional light guide plate in the LCD. In addition, a layer of transparent fluorescent films that function as a color filter can be formed on the TFT array substrate in accordance with some embodiments. In some embodiments, the layer of transparent fluorescent films includes red, green, and blue transparent fluorescent films. Thus, a conventional color filter can also be omitted from the LCD according to the disclosed embodiments. Accordingly, devices made with the LCDs described herein can be thinner and lighter than conventional LCD devices.

Furthermore, some embodiments use a UV light source instead of a white light source which is used in conventional LCDs. Energy efficiency can be improved by using UV light instead of white light, because with white light, energy loss occurs when certain color components of white light are absorbed during the color filtering process. In some embodiments, a UV light source that emits three primary colors can be used.

FIG. 1 illustrates a cross sectional view of a conventional LCD 100. There are illustrated a top polarizer 110, a color filter 120, a substrate for the color filter 130, a liquid crystal layer 140, a TFT array substrate 150, and a bottom polarizer 160, The TFT array substrate 150 can be a substrate on which a TFT array is formed. FIG. 1 also illustrates a backlight unit 170, which includes a light guide plate 172, a white light source 180, a diffusing sheet 190, and a reflecting sheet 192. As illustrated in FIG. 1, the backlight unit 170 can be disposed beneath the TFT array substrate 150. The backlight unit 170 can add significant weight, thickness, costs, and complexity to a LCD 100 device. For clarity, other components of a LCD 100 (for example, alignment layers, electrodes), which are well known in the art, are not illustrated in FIG. 1.

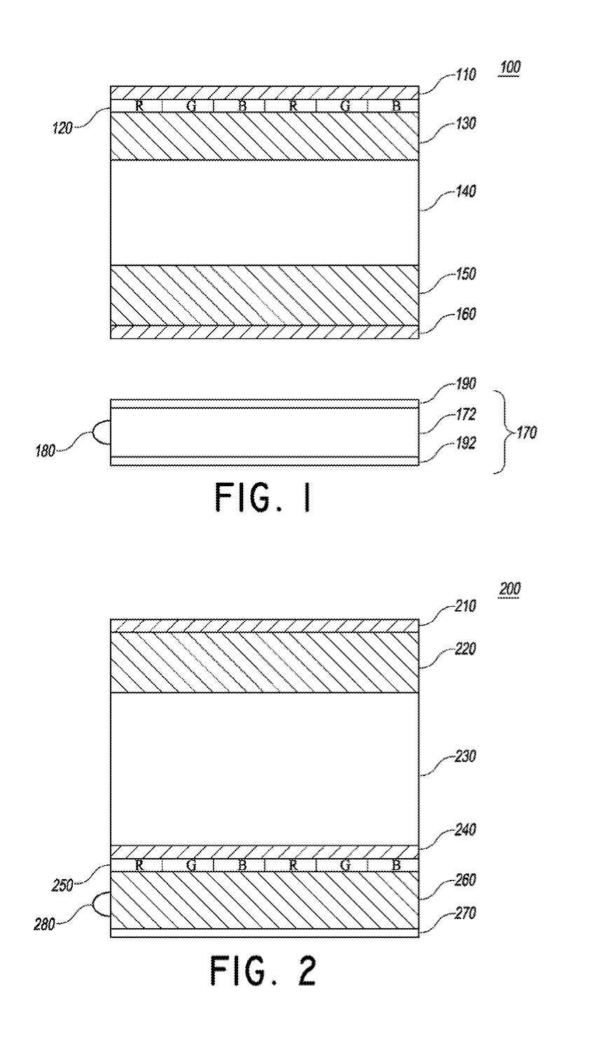

FIG. 2 illustrates a side cross sectional view of a LCD 200 according to some embodiments. Compared to FIG. 1, FIG. 2 illustrates fewer components. For example, FIG. 2 does not illustrate a light guide plate 172 or a conventional color filter 120. In some embodiments, those components are omitted from a LCD 200. FIG. 2 illustrates a top polarizer 210, a substrate without a color filter formed thereon 220, a liquid, crystal layer 230, a bottom polarizer 240, a layer of transparent fluorescent films 250 formed on a TFT array substrate 260, a TFT array substrate 260, a UV light source 280, and a reflecting sheet 192. As illustrated in FIG. 2, the UV light source 280 can be disposed at an edge of the TFT array substrate 260 to project light through the TFT array substrate 260. In other embodiments, the UV light source 280 can be disposed beneath the TFT array substrate and opposite a top surface of the TFT array substrate, which has the layer of transparent fluorescent films 250 formed thereon. In embodiments where the UV light source 280 is disposed at an edge of the TFT array substrate 260, a reflecting sheet 270 can be used to direct light away from the bottom of the TFT array substrate 260 and through the top of the TFT array substrate 260 toward the other components of the LCD 200.

Referring to FIG. 2, the layer of transparent fluorescent films 250 can function as a color filter that filters color emitted from the UV light source 280. Accordingly, a conventional filter 120 can be omitted from the LCD 200. In some embodiments, the TFT array substrate 260, the LTV light source 280, and the layer of transparent fluorescent films 250 formed on the TFT array 260 serve as the backlight unit of a LCD 100. Because the UV light source 280 can be installed at an edge (or the bottom) of the TFT array substrate 180, UV light can be projected directly through the TFT array substrate 260 and to the layer of transparent fluorescent films 250 and the other components of the LCD 200 (for example, polarizers, liquid crystal layer, alignment layer, and so on). Accordingly, a separate light guide plate 172 can be omitted from the LCD 200. By omitting the light guide plate 172 and the conventional color filter 120 from the LCD 200, the LCD 200 can have less weight, less thickness, less complexity and lower costs to manufacture as compared to conventional LCDs 100.

In some embodiments, the light source 280 is a UV light source 280 as opposed to a white light source 180 which is used in conventional LCDs 100. Because color filters 120 produce color by absorbing certain color components and emitting others, energy loss occurs when certain color components of white light are absorbed. In contrast, by using a UV light source 280 emitted in three primary colors, the LCDs 200 according to the some embodiments improve energy efficiency.

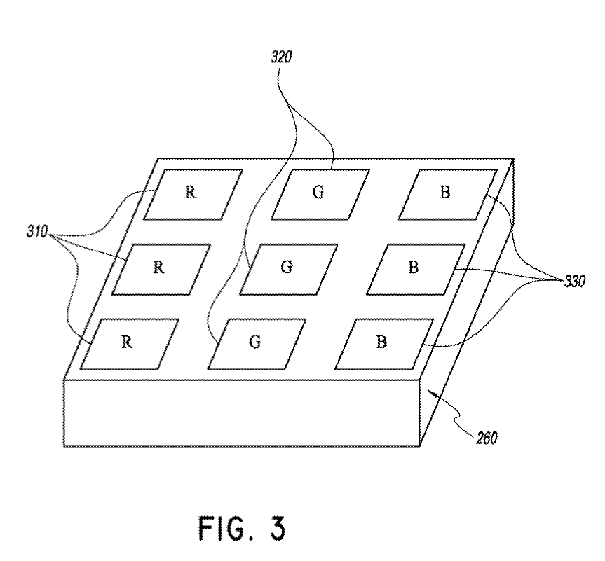

FIG. 3 illustrates a top perspective view of a layer of transparent fluorescent films 250 formed on the top surface of a TFT array substrate 260. The layer of transparent fluorescent films 250 can function as a color filter according to some embodiments. In contrast to conventional color filters, however, the layer of transparent fluorescent films 250 according to some embodiments do not suffer absorption loss, because the layer of transparent fluorescent films 250 emits only the red, green, or blue color. Conventional color filters may suffer absorption loss, because they produce color by absorbing certain color components. The thickness of the layer of transparent fluorescent films 250 can be about 10 μm to about 200 μm, such as 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, or a thickness in between any of these values. For example, the thickness of the layer of transparent fluorescent films 250 can be about 25 μm.

In some embodiments, the layer of transparent fluorescent films 250 can include a plurality of red transparent fluorescent films 310, a plurality of green transparent fluorescent films 320, and a plurality of blue transparent fluorescent films 330. Referring to FIG. 3, each plurality of different colored fluorescent films can be formed on a different subset of pixels on the top surface of the TFT array substrate 260. Specifically, the red transparent fluorescent films 310 can be formed on one subset of pixels, the green transparent fluorescent films 320 can be formed on another subset of pixels, and the blue transparent fluorescent films 330 can be formed on another subset of pixels. The red, green, and blue transparent fluorescent films 310, 320, 330, can be arranged in a RGB three color pattern according to those patterns known in the art.

The red, green, and blue transparent fluorescent films 310, 320, 330 can be made of a material that emits each respective color light when excited by UV light. Thus, when light from the UV light source 280 (shown in FIG. 2) is incident on the red transparent fluorescent films 310, red light can be emitted. Similarly, when light from the UV light source is incident on the green transparent fluorescent films 320, green light can be emitted. Similarly, when light from the UV light source is incident on the blue transparent fluorescent films 330, blue light can be emitted. In this manner, the layer of transparent fluorescent films 250 (shown in FIG. 2) can act as a color filter. The red, green, and blue transparent fluorescent films 310, 320, 330 can also be made of a transparent resin, such as acrylic resin. In some embodiments, the transparent fluorescent films can also be made of polyurethane resin, polyethylene terephthalate, triacetylcellulose, polyethylene naphthalate, cycloolefin polymer, or a combination thereof.

In some embodiments, the transparent resin has high permittivity so that stable electric fields can be applied to the LCD 200.

The material of the red transparent fluorescent film 310 can include a complex in which tri-n-butyl phosphate and thenoyltrifluoroacetone are coordinated with europium (Eu³⁺), as shown by formula (1) below.

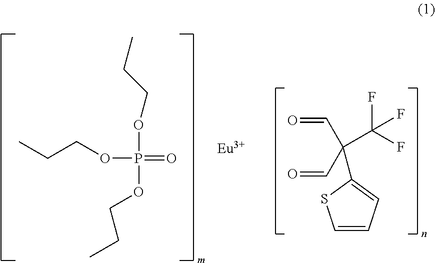

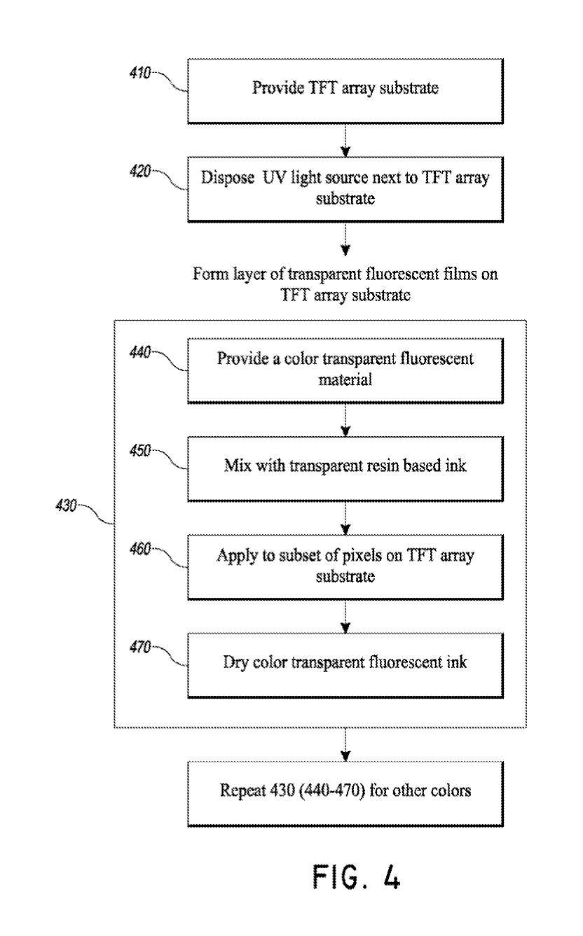

Thenoyltrifluoroacetone can be present in the complex in an amount of about 0.1% to about 50% by weight, such as about 0.1%, 10%, 20%, 30%, 40%, 50%, or an amount in between any of these values by weight. For example, the complex can have about 24% thenoyltrifluoroacetone by weight. In some embodiments, the material of a green transparent fluorescent film 320 can include a complex in which 1,10-phenanthroline and a β diketone are coordinated with terbium (Tb³⁺). Examples of β diketone include acetylacetone, trifluoroacetylacetone, and hexafluoroacetylacetone. In other embodiments, the material of the green transparent fluorescent film can include a complex in which phenylpyridine is coordinated with iridium (Ir³⁺). The material of the blue transparent film 330 can include a fluorescent brightening agent, such as a derivative of bis(triazinylamino), a derivative of bis-strylbiphenyl, or 2,5-bis(5-tert-butly-2-benzoxazolyl) thiophen. These materials for the red, green, and blue transparent fluorescent films 310, 320, 330 can emit each respective color light when excited by UV light. In some embodiments, the complexes of the red, blue, and green films can be made by chemical synthesis. FIG. 4 illustrates a method of making a backlight unit for a LCD. At step 410, a TFT array substrate 260 can be provided. At step 420, a UV light source 280 can be disposed next to the TFT array substrate 260, such that the UV light source 280 projects light through the TFT array substrate 260. For example, the UV light source 280 can be installed at an edge of or beneath the TFT array substrate 260. At step 430, a layer of transparent fluorescent films 250 can be formed on the TFT array substrate 260. Step 420 (disposing a UV light source 280 next to the TFT array substrate 260) can be performed before or after step 430 (forming a layer of transparent fluorescent films 250 on the TFT array substrate 260).

In some embodiments, step 430 (forming a layer of transparent fluorescent films 250 on a TFT array substrate 260) may be repeated for red, green, and blue transparent fluorescent films 310, 320, 330, on different subsets of pixels on the TFT array substrate 260. In some embodiments, the TFT array substrate 260 can be a substrate on which a TFT array is already formed. In other embodiments, the TFT array substrate 260 can be a substrate on which a TFT array will be formed. Thus, the layer of transparent fluorescent films 250 can be formed on the TFT array substrate 260 before or after the TFT array is formed on the substrate 260.

Still referring to FIG. 4, there is illustrated a method of forming a layer of transparent fluorescent films 250 on as TFT array substrate 260. Specifically, at step 440, a color transparent fluorescent material is provided. This can be a red, green, or blue transparent fluorescent material. The components of the transparent fluorescent materials can be as described above with respect to FIG. 3. At step 450, the colored transparent fluorescent material can be mixed with a transparent resin based ink, thereby yielding a colored transparent fluorescent ink (for example, a red, green, or blue transparent fluorescent ink). In some embodiments, the resin may be present in the colored transparent fluorescent ink in an amount of about 10% by weight. As described above, the transparent resin can be an acrylic resin. In addition, in some embodiments, the transparent resin has high permittivity. At step 460, the color transparent fluorescent ink can be applied to a subset of pixels on the TFT array substrate 460. The ink can be applied according to any number of different methods, such as ink-jet printing, mimeographic printing, screen printing, intaglio printing, gravure printing, relief printing, flexo printing, using a dispenser, or any other suitable method. At step 470, the colored transparent fluorescent ink can be dried. Steps 440 to 470 can be repeated for the other colors. Thus, steps 440 to 470 can be performed, for example three times, each time for the red, green, and blue colors. Each time, the colored transparent fluorescent ink can be applied to a different subset of pixels on the TFT array substrate 260, in accordance with the desired pattern of red, green, and blue transparent fluorescent films 310, 320, 330.

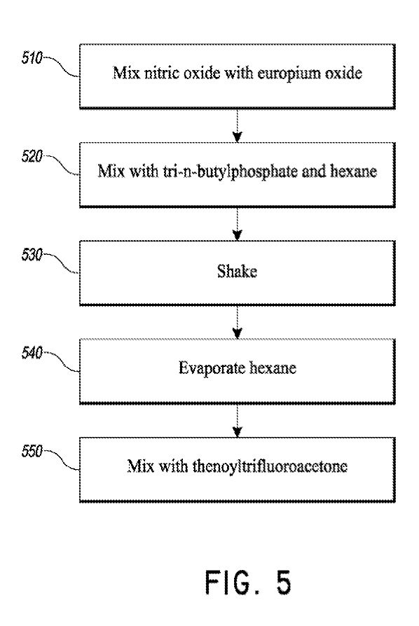

In some embodiments, the red, green and blue transparent fluorescent materials can be obtained commercially. For example, Examples 2 and 3 below describe commercially obtained green and blue transparent fluorescent materials, respectively. In some embodiments, the red transparent fluorescent material can be prepared according to the method illustrated in FIG. 5. In some embodiments, the blue and green transparent fluorescent materials can be prepared according to a chemosynthetic technique.

Referring to FIG. 5, there is illustrated a method for preparing a red transparent fluorescent material according to some embodiments. At step 510 nitric acid and europium oxide can be mixed, thereby yielding europium (Eu³⁺) nitrate. At step 520, the europium (Eu³⁺) nitrate can be mixed with hexane. At step 530, the mixture of europium (Eu³⁺) nitrate and hexane can be shaken, so that europium (Eu³⁺) ions are extracted from a liquid phase to an organic phase. At step 540, the hexane can be evaporated, thereby yielding a europium (Eu³⁺) tri-n-butylphosphate complex. At step 550, the europium (Eu³⁺) tri-n-butyl phosphate complex can be mixed with thenoyltrifluoroacetone, thus yielding a europium (Eu³⁺) tri-n-butyl phosphate and thenoyltrifluoroacetone complex, as shown by formula (1) above. In some embodiments, the red transparent fluorescent material includes this complex. As described above with respect to FIG. 4, the transparent fluorescent materials can be mixed with a transparent resin based ink, applied to a subset of pixels on the TFT array substrate 260, and dried, in order to form a layer of transparent fluorescent films on a TFT array substrate 260.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

### EXAMPLE 1

### Forming a Red Transparent Fluorescent Film on a Substrate

In a glass vessel, 12 grams of concentrated nitric acid (with a concentration, of 60% and a specific gravity of 1.38) was added to 6 grams of europium oxide. Due to the heat from the reaction of the nitric acid with the europium oxide, europium oxide was dissolved, yielding an aqueous solution of europium nitrate.

Tri-n-butyl phosphate (27 grams) and hexane (30 grams) were added to the aqueous solution of europium nitrate. The resulting solution was shaken vigorously for one minute to extract europium ions from the liquid phase to the organic phase. Next, the hexane was evaporated and removed from the solution by using an evaporator, yielding a transparent liquid composition in which tri-n-butylphosphate was coordinated with the europium ions.

Next, thenoyltrifluoroacetone was added to this composition in which tri-n-butylphosphate was coordinated with the europium ions, yielding a europium(Eu³⁺) tri-n-butyl phosphate and thenoyltrifluoroacetone complex, as shown by formula (1) above.

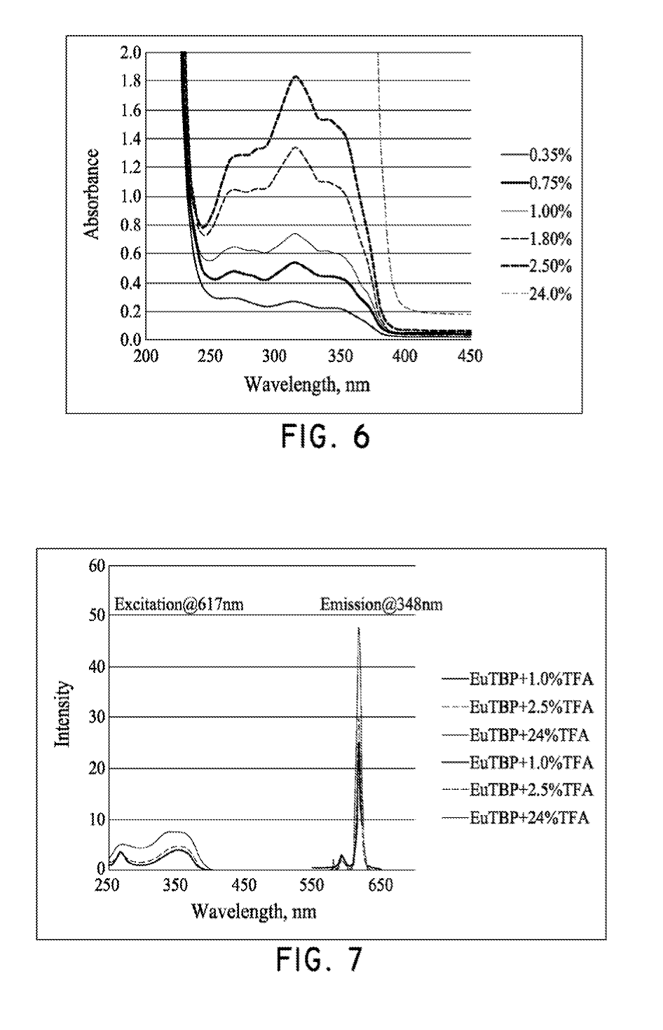

Six samples of the europium (Eu³⁺) tri-n-butyl phosphate and thenoyltrifluoroacetone complex were prepared, each with a different amount of thenoyltrifluoroacetane. The percentages of thenoyltrifluoroacetane in the six samples were 0.35%, 0.75%, 1.00%, 1.80%, 2.50%, and 24.0% by weight, respectively. The amount of ultraviolet light absorbed by the six samples was measured. The results are illustrated in FIG. 6. It was observed that samples with higher amounts of thenoyltrifluoroacetane showed increased ultraviolet absorption.

Each of the six samples was added to an acrylic-resin-based ink for screen printing (Super Gloss Ink 100, Jujo Chemical, Tokyo, Japan), in an amount corresponding to 10% resin by weight. The resulting solution was applied to a glass substrate, which was dried to form a red transparent fluorescent film having a thickness of 25 μm. Thus, six glass substrates, each having a red transparent fluorescent film with a different amount of thenoyltrifluoroacetane, were produced. The light excitation and emission spectra were measured for each of the six glass substrates having a red transparent fluorescent film. FIG. 7 shows the results. It was observed that the light emission intensity was higher for glass substrates that had higher amounts of thenoyltrifluoroacetane.

The resulting substrates with the red transparent fluorescent films formed thereon were effective in emitting red light when ultraviolet light was projected onto the substrate as can be seen from FIGS. 6 and 7.

### EXAMPLE 2

### Forming a Green Transparent Fluorescent Film on a Substrate

green transparent fluorescent material (Green 520 (triazoles or oxadiazoles), Harima Chemicals, Inc., Tokyo, Japan was added to a toluene solution, in an amount corresponding to 2% of the green transparent fluorescent material by weight. The toluene solution containing the green transparent fluorescent material was added to an acrylic-resin-based ink for screen printing (Super Gloss Ink 100, Jujo Chemical, Tokyo, Japan), in an amount corresponding to 10% resin by weight. The resulting composition was applied to a glass substrate, which was dried to form a green transparent fluorescent film having a thickness of 25 μm.

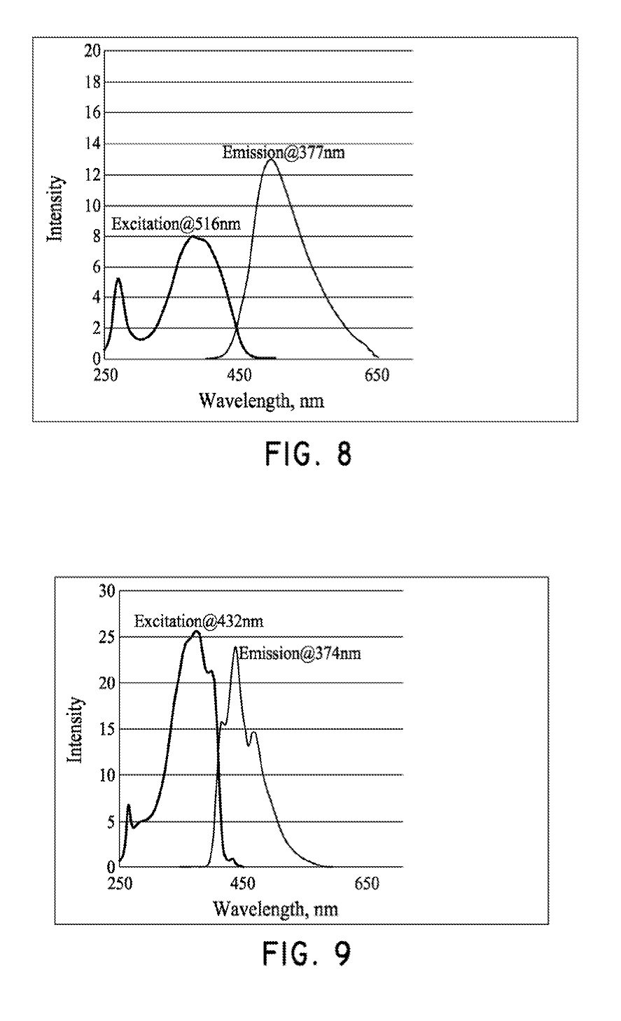

The light excitation and emission spectra were measured for the substrate having the green transparent fluorescent film. FIG. 8 shows the results. The resulting substrate with the green transparent fluorescent film formed thereon was effective in emitting green light when ultraviolet light was projected onto the substrate, as illustrated by FIG. 8.

### EXAMPLE 3

### Forming a Blue Transparent Fluorescent Film on a Substrate

blue transparent fluorescent film was formed on a glass substrate in the same manner as in Example 2, except that instead of a green transparent fluorescent material, a blue transparent fluorescent material (Tinopal OB (2,5-thiophenediylbis(5-tert-butyl-1,3-benzoxazole)), Ciba, Basel, Switzerland) was added to a toluene solution. The blue transparent fluorescent material is represented by the compound illustrated in formula (2).

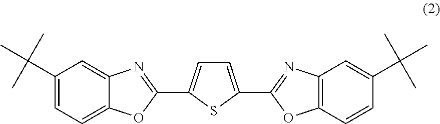 [SMILES: CC(C)(C)c1ccc2oc(-c3ccc(-c4nc5cc(C(C)(C)C)ccc5o4)s3)nc2c1]

The light excitation and emission spectra were measured for the substrate having a blue transparent fluorescent film. FIG. 9 shows the results. The resulting substrate with the blue transparent fluorescent film formed thereon was effective in emitting blue light when ultraviolet light was projected onto the substrate, as illustrated by FIG. 9.

### EXAMPLE 4

### Making and Using a Backlight Unite for a Liquid Crystal Display

red transparent fluorescent ink was prepared in the same manner described in Example 1. The europium (Eu³⁻) tri-n-butyl phosphate and thenoyltrifluoroacetone complex contained 24% thenoyltrifluoroacetone by weight.

A green ink was prepared by adding a green transparent fluorescent material (Green 520 (triazoles or oxadiazoles), Harima Chemicals) to a tri-n-butylphosphate solution. A tri-n-butylphosphate solution was chosen because the green ink was to be applied by ink-jet printing, and a tri-n-butylphosphate solution would minimize the chances of clogging up the ink-jet nozzle. The tri-n-butylphosphate solution containing the green transparent fluorescent material was added to a transparent resin based ink. The resulting green transparent fluorescent ink contained 1.88% of the green fluorescent transparent material by weight.

A blue ink was prepared by adding a blue transparent fluorescent material (Tinopal OB (2,5-thiophenediylbis(5-tert-butyl-1,3-benzoxazole)), Ciba) to a tri-n-butyl-phosphate solution. A tri-n-butylphosphate solution was chosen because the blue ink was to be applied by ink-jet printing, and a tri-n-butylphosphate solution would minimize the chances of clogging up the ink-jet nozzle. The tri-n-butylphosphate solution containing the blue transparent fluorescent material was added to a transparent resin based ink. The resulting blue transparent fluorescent ink contained 0.68% of the blue transparent fluorescent material by weight.

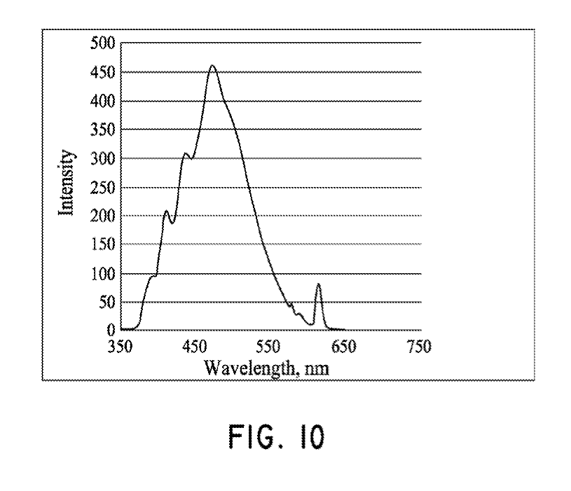

The red, green, and blue fluorescent inks were applied to an acrylic substrate by ink-jet printing in a mosaic pattern with uniform area ratios. The acrylic substrate was a UV-transparent poly-methacrylate cast board having a size of 100 mm×100 mm and a thickness of 5 mm (Paraglass UV00, Kuraray, Tokyo, Japan). The fluorescent inks were dried, thus forming fluorescent films on the acrylic substrate. An ultraviolet LED lamp (NS375L-3RLQ, Nitride Semiconductor Co., Ltd., Tokushima, Japan) was installed at an edge of the acrylic substrate. When the ultraviolet LED lamp emitted light, intense white light emission, which included blue, green, and red emission, was achieved. The resulting emission spectrum is illustrated in FIG. 10.

A TFT array was formed on the acrylic substrate with the fluorescent films. In addition, an ITO (indium tin oxide) layer was formed on the acrylic substrate. A polarizer was disposed on top of the fluorescent films formed on the acrylic substrate. A UV light source was disposed at an edge of the acrylic substrate and a reflecting sheet was disposed at the bottom of the acrylic substrate opposite the side of the substrate having the fluorescent films. An ITO layer was formed on a second substrate. A second polarizer was disposed on top of the second substrate. A spacer was placed between the bottom of the second substrate and the polarizer on top of the first acrylic substrate. A liquid crystal layer was inserted in the space created by the spacer.

Light was projected from the UV light source and through the acrylic substrate, which had a layer of transparent fluorescent films and a TFT array formed thereon. The UV light was incident on the fluorescent films, thus exciting the fluorescent films and causing them to emit red, green, and blue colors. Therefore, it can be shown that the LCD in accordance with the disclosed embodiments can emit the respective colored lights without the need for a color filter. Also, as the UV light projected directly through the TFT array, there is no need for a light guide plate like in conventional LCDs.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” and so on). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, and so on” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and so on). In those instances where a convention analogous to “at least one of A, B, or C, and so on” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, and so on). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B”.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, and so on. As a non-limiting example, each range discussed herein can be readily broken down into a lower third, middle third and upper third, and so on. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A backlight unit, comprising:
a thin film transistor array substrate;
at least one ultraviolet light source configured to project ultraviolet light through the thin film transistor array substrate; and
at least one layer of transparent fluorescent films formed on a top surface of the thin film transistor array substrate, wherein the layer comprises:
a plurality of red transparent fluorescent films formed on a first subset of pixels on the top surface of the thin film transistor array substrate;
a plurality of green transparent fluorescent films formed on a second subset of pixels on the top surface of the thin film transistor array substrate; and
a plurality of blue transparent fluorescent films formed on a third subset of pixels on the top surface of thin film transistor array substrate, wherein the layer of transparent fluorescent films is configured to filter color.

2. The backlight unit of claim 1, wherein:
the red transparent fluorescent films comprise a first material configured to emit red light when excited by the ultraviolet light;
the green transparent fluorescent films comprise a second material configured to emit green light when excited by the ultraviolet light; and
the blue transparent fluorescent films comprise a third material configured to emit blue light when excited by the ultraviolet light.

3. The backlight unit of claim 1, wherein the red transparent fluorescent films, the green transparent fluorescent films, and the blue transparent fluorescent films comprise a transparent resin.

4. The backlight unit of claim 1, wherein the red transparent fluorescent films comprise a europium (Eu³+) tri-n-butyl phosphate and thenoyltrifluoroacetone complex.

5. The backlight unit of claim 4, wherein the europium (Eu³+) tri-n-butyl phosphate and thenoytrilfluoroacetone complex has about 0.1% to about 50% thenoyltrifluoroacetone by weight.

6. The backlight unit of claim 4, wherein the europium (Eu³+) tri-n, butyl phosphate and thenoyltrifluoroacetone complex has about 24% thenoyltrifluoroacetone by weight.

7. The backlight unit of claim 1, wherein the green transparent fluorescent films comprise an iridium (Ir³+) phenylpyridine complex.

8. The backlight unit of claim 1, wherein the green transparent fluorescent films comprise a terbium (Tb³+) 1,10-phenanthroline and diketone complex.

9. The backlight unit of claim 8, wherein the diketone complex is acetylacetone, trifluoroacetylacetone, or hexafluoroacetylacetone.

10. The backlight unit of claim 1, wherein the blue transparent fluorescent films comprise a fluorescent brightening agent.

11. The backlight unit of claim 10, wherein the fluorescent brightening agent comprises a derivative of bis(triazinylamino), a derivative of bis-styrylbiphenyl, or 2,5-bis(5-tert-butly-2-benzoxazolyl) thiophen.

12. The backlight unit of claim 1, wherein the ultraviolet light source is disposed at an edge of the thin film transistor array substrate.

13. The backlight unit of claim 1, wherein the ultraviolet light source is disposed beneath the thin film transistor array substrate opposite a top surface of the thin film transistor array substrate, the top surface having the layer of transparent fluorescent films formed thereon.

14. The backlight unit of claim 1, wherein the red transparent fluorescent films, the green transparent fluorescent films, and the blue transparent fluorescent films are arranged in a RGB three-color pattern.

15. A liquid crystal display comprising:
a backlight unit comprising:
a thin film transistor array substrate;
at least one ultraviolet light source configured to project ultraviolet light through the thin film transistor array substrate; and
at least one layer of transparent fluorescent films formed on the thin film transistor array substrate, wherein the layer comprises:
a plurality of red transparent fluorescent films formed on a first subset of pixels on the thin film transistor array substrate;
a plurality of green transparent fluorescent films formed on a second subset of pixels on the thin film transistor array substrate; and
a plurality of blue transparent fluorescent films formed on a third subset of pixels on the thin film transistor array substrate, wherein the layer of transparent fluorescent films is configured to filter color;
a liquid crystal layer disposed above the layer of transparent fluorescent films; and
a glass substrate without a color filter formed thereon, wherein the glass substrate is disposed above the liquid crystal layer.

16. A device comprising a liquid crystal display, the device comprising
a liquid crystal display comprising:
a backlight unit comprising:
a thin film transistor array substrate;
at least one ultraviolet light source configured to project ultraviolet light through the thin film transistor array substrate; and
at least one layer of transparent fluorescent films formed on the thin film transistor array substrate, wherein the layer comprises:
a plurality of red transparent fluorescent films formed on a first subset of pixels on the thin film transistor array substrate;
a plurality of green transparent fluorescent films formed on a second subset of pixels on the thin film transistor array substrate; and
a plurality of blue transparent fluorescent films formed on a third subset of pixels on the thin film transistor array substrate, wherein the layer of transparent fluorescent films is configured to filter color;
a liquid crystal layer disposed above the layer of transparent fluorescent films; and
a glass substrate without a color filter formed thereon, wherein the glass substrate is disposed above the liquid crystal layer, wherein the device is a mobile device, a cell phone, a tablet, a computer, a television, a monitor, or a display.

17. A method of making a backlight unit, comprising:
providing a thin film transistor array substrate;
disposing at least one ultraviolet light source at an edge of or beneath the thin film transistor array substrate so that the at least one ultraviolet light source is configured to project ultraviolet light through the thin film transistor array substrate; and
forming at least one layer of transparent fluorescent films configured to filter color on a thin film transistor array substrate, wherein forming the layer comprises:
forming a plurality of red transparent fluorescent films on a first subset of pixels on the thin film transistor array substrate;
forming a plurality of green transparent fluorescent films on a second subset of pixels on the substrate; and
forming a plurality of blue transparent fluorescent films on a third subset of pixels on the substrate.

18. The method of claim 17, wherein the red, green and blue transparent fluorescent films are arranged in a RGB three-color pattern when formed on the substrate.

19. The method of claim 17, wherein forming the plurality of red transparent fluorescent films comprise:
providing a red transparent fluorescent material;
mixing the red transparent fluorescent material with a transparent resin based ink, thereby yielding a red transparent fluorescent ink;
applying the red transparent fluorescent ink to the first subset of pixels on the thin film transistor array substrate; and
drying the red transparent fluorescent ink.

20. The method of claim 17, wherein forming the plurality of green transparent fluorescent films comprise:
providing a green transparent fluorescent material;
mixing the green transparent fluorescent material with a transparent resin based ink, thereby yielding a green transparent fluorescent ink;
applying the green transparent fluorescent ink to the second subset of pixels on the thin film transistor array substrate; and
drying the green transparent fluorescent ink.

21. The method of claim 17, wherein forming the plurality of blue transparent fluorescent films comprise:
providing a blue transparent fluorescent material;
mixing the blue transparent fluorescent material with a transparent resin based ink, thereby yielding a blue transparent fluorescent ink;
applying the blue transparent fluorescent ink to the third subset of pixels on the thin film transistor array substrate; and
drying the blue transparent fluorescent ink.

22. The method of claim 19, wherein the applying comprises inkjet printing, mimeographic printing, screen printing, intaglio printing, gravure printing, relief printing, flexo printing, or using a dispenser.

23-37. (canceled)
